(19) United States
(12) Patent Application Publication
(10) Pub. No.: US 2023/0419003 A1
(43) Pub. Date: Dec. 28, 2023

(54) MODELLING FLUID FLOW

(71) Applicant: Autodesk, Inc., San Francisco, CA (US)

(72) Inventors: Franco Costa, Melbourne (AU); Sejin Han, Ithaca, NY (US)

(21) Appl. No.: 17/849,483

(22) Filed: Jun. 24, 2022

(51) Int. Cl. G06F 30/28

(52) U.S. Cl. CPC G06F 30/28; G06F 2111/10

(57) ABSTRACT

A digital 3D model of a component to be analyzed is obtained. The component includes regularly patterned holes. A first portion of the model is identified. The first portion includes the regularly patterned holes. A second portion of the model is identified. The second portion includes parts of the model lacking the regularly patterned holes. A flow factor of the first portion is determined. The flow factor indicates flow characteristics of fluid flowing through the first portion with the regularly patterned holes. A numerical fluid simulation is performed using a mesh representative of the component geometry. Performing the numerical fluid simulation includes modifying a flow property of the fluid simulation in the first portion based at least in part on the flow factor.

### TECHNICAL FIELD

This application relates to modelling fluid flow, for example, for injection molding.

### BACKGROUND

In various industries, injection molds are used to manufacture parts, where a material (e.g., plastic resin, such as thermoplastic, thermosetting or elastomer material, metal, etc.) is prepared in a liquid form (e.g. heated and melted), and then piped or injected under pressure into the voids of an empty mold (also referred to as a die) and then cools or undergoes a chemical reaction so as to permanently harden in the shape of the hollow mold cavity. The cavity of the mold has a shape corresponding to the part to be manufactured, and other components often include a mold core that fits into the cavity and a clamp that attaches to the mold to maintain an appropriate amount of pressure on the liquid in the mold cavity as the liquid is solidified.

The solidified and set material is removed from the mold, forming the near finished product, piece, or part in the shape of the mold. Injection molding can be an efficient method of production in that it typically allows manufacturers to reuse one or more dies and reproduce, with precision, the products formed in the die. Typically, the initial design and manufacture of the mold is quite costly. Much is invested to design and perfect a mold that will be reused, in some instances, millions of times over the course of its life. Consequently, injection molding is often characterized by high efficiencies of scale, the return on investment for a particular die dependent on the durability and lasting precision of the die. As a result, typical injection mold cavity design is at the same time a critically important, but difficult and costly process.

Thousands of polymer materials exist capable of being used in injection molding applications. In some instances, the material that is to be used in an injection molding application can even influence the design of a given mold cavity and vice versa. For instance, some high viscosity materials, in their molten form, may perform poorly in a mold cavity machined with narrow gates, runners, and cavity voids. Additionally, the geometry of the mold cavity can also influence the physical properties of plastic parts manufactured using the mold. Indeed, two parts having identical dimensions and made from the same thermoplastic material but molded under different conditions, with different injection locations, for instance, can possess different stress and shrinkage levels.

### SUMMARY

This disclosure describes technologies relating to modelling fluid flow.

An example of the subject matter described within this disclosure is a method performed by a data processing apparatus. The method includes the following features. A digital 3D model of a component to be analyzed is obtained. The component includes regularly patterned holes. A first portion of the model is identified. The first portion includes the regularly patterned holes. A second portion of the model is identified. The second portion includes parts of the model lacking the regularly patterned holes. A flow factor of the first portion is determined. The flow factor indicates flow characteristics of fluid flowing through the first portion with the regularly patterned holes. A numerical fluid simulation is performed using a mesh representative of the component geometry. Performing the numerical fluid simulation includes modifying a flow property of the fluid simulation in the first portion based at least in part on the flow factor.

Aspects of the example method, which can be combined with the example method alone or in combination with other aspects, include the following. A thermal factor is determined. The thermal factor is indicative of thermal characteristics of fluid flowing through the first portion with the regularly patterned holes. The thermal factor includes a growth rate of a frozen layer.

Aspects of the example method, which can be combined with the example method alone or in combination with other aspects, include the following. The flow factor dynamically modified to account for a growth rate of a frozen layer.

Aspects of the example method, which can be combined with the example method alone or in combination with other aspects, include the following. The regularly patterned holes are included in the digital 3D model. The method further includes the following features. The holes are removed from the 3D model. The mesh used to perform the numerical fluid simulation is created after removing the holes in the 3D model.

Aspects of the example method, which can be combined with the example method alone or in combination with other aspects, include the following. The regularly patterned holes are omitted from the digital 3D model. The method further includes the following features. Flow characteristics of the first portion of the model are obtained using analytical flow results or empirical flow data. Determining the flow factor is done based on the analytical flow results or the empirical flow data. Thermal characteristics of the first portion of the model are obtained using analytical thermal results or empirical thermal data. A thermal is determined factor based on the analytical thermal results or the empirical thermal data. Fiber orientation characteristics of the first portion of the model are obtained using analytical results or empirical fiber orientation data for fibers suspended in the fluid flow. A fiber orientation factor is determined based on the analytical results or the empirical fiber orientation data.

Aspects of the example method, which can be combined with the example method alone or in combination with other aspects, include the following. The regularly patterned holes include blind holes. Determining the flow factor includes obtaining flow characteristics of the blind holes using analytical results or empirical data.

Aspects of the example method, which can be combined with the example method alone or in combination with other aspects, include the following. The regularly patterned holes include a varied profile hole. The varied profile hole defines a varied cross-sectional shape across a depth of the hole. Determining the flow factor includes obtaining flow characteristics of the varied profile hole using analytical results or empirical data.

An example implementation of the subject matter described within this disclosure is a system with the following features. A computer-readable medium stores instructions executable by one or more processors to cause the one or more processors perform the following operations. A digital 3D model of a component to be analyzed is obtained. The component includes regularly patterned holes. A first portion of the model is identified. The first portion includes the regularly patterned holes. A second portion of the model is identified. The second portion includes parts of the model lacking the regularly patterned holes. A thermal factor of the first portion is determined. The thermal factor is indicative of a thermal characteristic of fluid flowing through the first portion with the regularly patterned holes. The thermal factor includes a growth rate of a frozen layer. A numerical fluid simulation is performed using a mesh representative of the component geometry. Performance of the numerical fluid simulation includes modifying a thermal property of the numerical fluid simulation in the first portion based at least in part on the thermal factor. The numerical fluid simulation is used to determine an injection flow rate or an injection location of an injection mold.

Aspects of the example system, which can be combined with the example system alone or in combination with other aspects, include the following. The regularly patterned holes are included in the digital 3D model. The instructions further cause the one or more processor to perform the following operations. The holes in the 3D model are removed. The mesh is created after removal of the holes in the 3D model.

Aspects of the example system, which can be combined with the example system alone or in combination with other aspects, include the following. The regularly patterned holes are omitted from the digital 3D model. The instructions further cause the one or more processor to perform the following operations. Flow characteristics of the first portion of the model are obtained using analytical flow results or empirical flow data. A flow factor of the first portion is determined. The flow factor is indicative of flow characteristics of fluid flowing through the first portion with the regularly patterned holes. Determination of the flow factor is done based on the analytical flow results or the empirical flow data. Thermal characteristics of the first portion of the model are obtained using analytical thermal results or empirical thermal data. Determination of the thermal factor is done based on the analytical thermal results or empirical thermal data. Fiber orientation characteristics of the first portion of the model are obtained using analytical results or empirical fiber orientation data for fibers suspended in the fluid flow. A fiber orientation factor is determined based on the analytical results or the empirical fiber orientation data.

Aspects of the example system, which can be combined with the example system alone or in combination with other aspects, include the following. The instructions further cause the one or more processor to perform the following operations. The flow factor is dynamically modified to account for the growth rate of the frozen layer.

Aspects of the example system, which can be combined with the example system alone or in combination with other aspects, include the following. The regularly patterned holes include blind holes. The instructions further cause the one or more processor to perform the following operations. The flow factor is determined by obtaining flow characteristics of the blind holes using analytical results or empirical data.

Aspects of the example system, which can be combined with the example system alone or in combination with other aspects, include the following. The regularly patterned holes include a varied profile hole that defines a varied cross-sectional shape across a depth of the hole. The instructions further cause the one or more processor to perform the following operations. The flow factor is determined by obtaining flow characteristics of the varied profile hole using analytical results or empirical data.

An example of the subject matter within this disclosure is a computer-readable medium storing instructions executable by one or more processors to perform the following operations. A digital 3D model of a component to be analyzed is obtained. The component includes regularly patterned holes. A first portion of the model is identified. The first portion includes the regularly patterned holes. A second portion of the model is identified. The second portion includes parts of the model lacking the regularly patterned holes. A fiber orientation factor is determined. The fiber orientation factor is indicative of fiber orientation characteristics indicative of fiber orientation properties of fibers suspended within a fluid flowing through the first portion with the regularly patterned holes. A numerical fluid simulation is performed using mesh representative of the component geometry. Performing the numerical simulation includes modifying a fiber orientation property of the numerical fluid simulation in the first portion based at least in part on the fiber orientation factor.

Aspects of the example system, which can be combined with the example system alone or in combination with other aspects, include the following. The operations further include the following. A flow factor of the first portion is determined. The flow factor indicates flow characteristics of fluid flowing through the first portion with the regularly patterned holes. A thermal factor of the first portion is determined. The thermal factor is indicative of thermal characteristic of fluid flowing through the first portion with the regularly patterned holes. The thermal factor includes a growth rate of a frozen layer.

Aspects of the example system, which can be combined with the example system alone or in combination with other aspects, include the following. The operations further include the following. The flow factor is dynamically modified to account for the growth rate of the frozen layer.

Aspects of the example system, which can be combined with the example system alone or in combination with other aspects, include the following. The regularly patterned holes include blind holes. Determining the flow factor includes obtaining flow characteristics of the blind holes using analytical results or empirical data.

Aspects of the example system, which can be combined with the example system alone or in combination with other aspects, include the following. The regularly patterned holes comprise a varied profile hole. The varied profile hole defines a varied cross-sectional shape across a depth of the hole. Determining the flow factor includes obtaining flow characteristics of the varied profile hole using analytical results or empirical data.

Aspects of the example system, which can be combined with the example system alone or in combination with other aspects, include the following. The operations further include the following. An injection rate is determined, with iterative calculations using the mesh, based in part on the determined flow factor and the determined thermal factor. An injection temperature is determined, with iterative calculations using the mesh, based in part on the determined flow factor and the determined thermal factor. An injection location is determined, with iterative calculations using the mesh, based in part on the determined injection rate and injection temperature.

Aspects of the example system, which can be combined with the example system alone or in combination with other aspects, include the following. The regularly patterned holes are included in the digital 3D model. The operations further include the following. The holes are removed from the 3D model. The mesh is created after removing the holes in the 3D model.

Particular implementations of the subject matter described in this disclosure can be implemented so as to realize one or more of the following advantages. The subject matter described herein allows for coarser meshes to be used during numerical simulations, reducing the time to perform numerical simulations. Such a mesh includes fewer discrete points used for iterative calculations and thus uses less memory of a data processing apparatus performing the calculations when compared to simulations using other methods. The subject matter described herein increases the speed of design and manufacturing of tooling in part due to the reduced computing time. The subject matter described herein allows for reduced CAD model preparation time because the effect of the holes can be studied without the need for explicitly including thousands of holes in CAD design. The subject matter described herein allows for simulations with different hole configurations to be more easily adjusted by changing factors related to the hole configurations rather than actually modifying the geometry/mesh each time.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flowchart of an example of a method that can be used with aspects of this disclosure.

FIG. 2 is an example of a component to be modelled.

FIG. 2A is an example of a 3D model of a component having a portion with regularly patterned holes.

FIG. 2B is an example of a 3D model of a component having a portion with regularly patterned holes with the holes removed.

FIG. 3A is a result of a simulation with the example 3D model of a component having a portion with regularly patterned holes.

FIG. 3B is a result of a simulation with the example 3D model of a component having a portion with regularly patterned holes with the holes removed.

FIG. 4A is a result of a simulation with the example 3D model of a component having a portion with regularly patterned holes.

FIG. 4B is a result of a simulation with the example 3D model of a component having a portion with regularly patterned holes with the holes removed.

FIG. 5 is a block diagram illustrated an example of a processing apparatus that can be used with aspects of this disclosure.

Like reference numbers and designations in the various drawings indicate like elements.

### DETAILED DESCRIPTION

The number of pin connectors (holes) for Central Processing Unit (CPU) Sockets continues to increase year after year. The increased pin count increases the computational power needed to model injection molding of such sockets. A simplification method which can produce reasonably accurate predictions with a one or two order reductions in model preparation time and computation time would provide savings in both time and power usage. Other applications where a repeating pattern of through-holes or blind-holes occur in the injection molding flow cavity are in speaker grills, sieves and repeating prismatic patterns in light-guides, lens (e.g., car headlamp lenses) and reflectors. The repeating pattern of small prismatic indentations in a headlamp lens is an example of a high-value part with many blind holes. The prismatic pattern increases thermal contact area and flow resistance but is often not modelled in the injection molding simulation due to the very high discretization resolution which would be required. This disclosure describes a method that reduces computation time by replacing discrete holes in a model with global factors, such as a flow factor, a thermal factor, and/or a fiber orientation factor (for reinforced molded parts, such as injection molded parts, over molded parts, and/or insert molded parts), that produce substantially similar results (for example, within 5%, within 10%, within 15%, or within 20%) to numerical analysis on a full model.

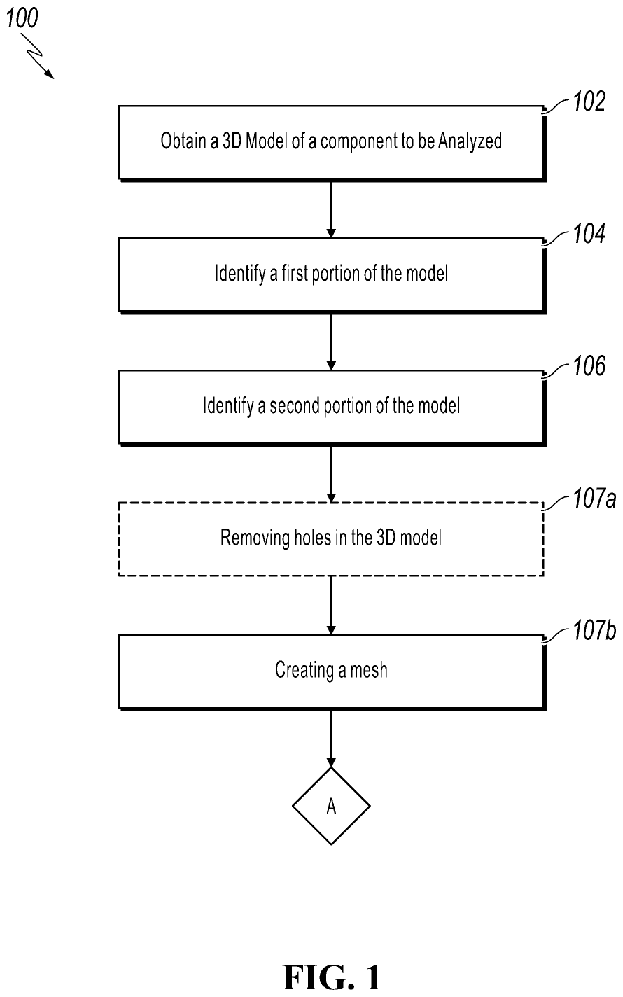

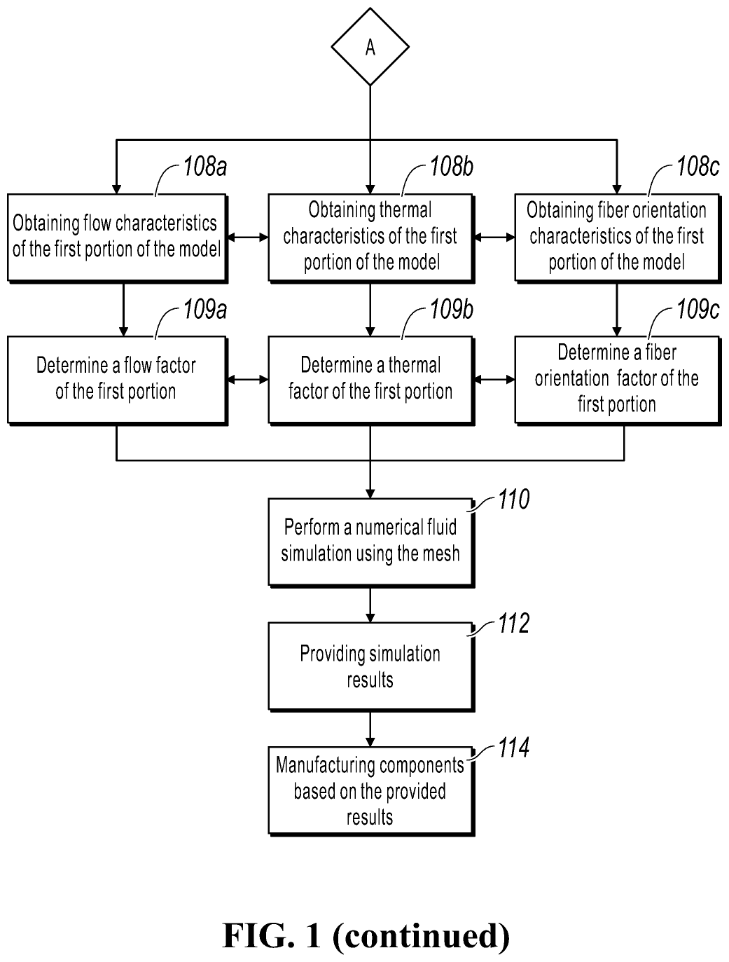

FIG. 1 is flowchart of an example method 100 that can be used with aspects of this disclosure. This disclosure will describe the operations of method 100 in the context of the remaining figures within this disclosure. The operations described are performed by a data processing apparatus. In some implementations, such an apparatus includes one or more processors and a computer-readable medium storing instructions executable by the one or more processors to perform the instructions. Alternatively or in addition, the operations described herein can be stored in a readable format to be used by a separate data processing apparatus.

At 102, a digital 3D model of a component to be analyzed is obtained. The component includes regularly patterned holes. In some instances, the regularly patterned holes include through-holes that extend an entire thickness of the component. Alternatively or in addition, in some implementations, the regularly patterned holes include blind holes that extend only partially through the thickness of the component. Alternatively or in addition, the regularly patterned holes includes one or more varied profile holes that define varied profile(s) with a varied cross-sectional shape across a depth of the hole. Such a varied profile hole can be a blind-hole or a through-hole without departing from this disclosure. Additional styles of holes can be used without departing from this disclosure.

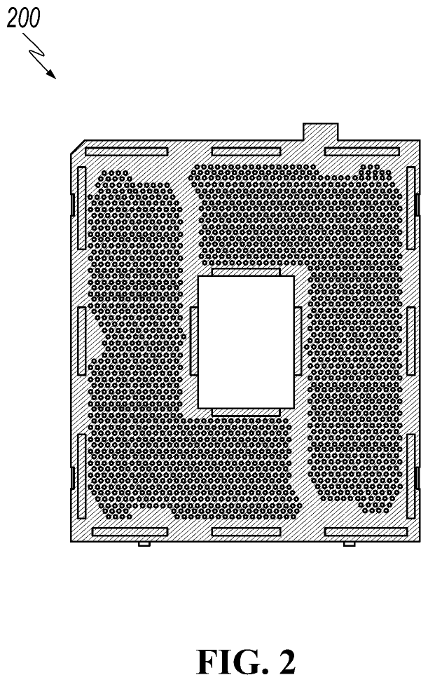

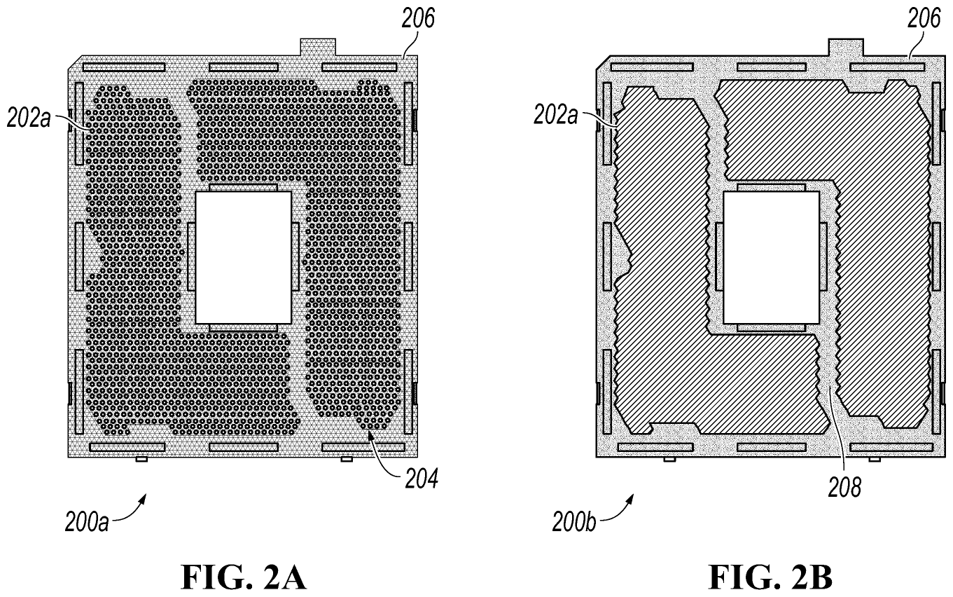

FIG. 2 is an example of a component 200 to be modelled. Example models 200a and 200b of a component 200 are illustrated in FIGS. 2A and 2B. FIG. 2A is an example 3D model 200a of the component 200 having a first portion 202a with regularly patterned holes. FIG. 2B is an example 3D model 200b of the component 200 having a first portion 202b with regularly patterned holes with the holes removed. While primarily described and illustrated within this disclosure as being of uniform size, shape, and configuration, the subject matter described herein can be used with other configurations, such as with hole-patterns with varying distances or shapes relative to one another.

At 104, a first portion (202a, 202b) of the component 200, the first portion including regularly patterned holes 204, is identified. This first portion (202a, 202b) is sometimes referred to as a grill portion, and the terms may be used interchangeably throughout this disclosure. At 106, a second portion 206 of the component 200, the second portion 206 lacking the regularly patterned holes 204, is identified. In instances where the model includes the regularly patterned holes, such as model 200a, at 107a, the holes are removed to produce model 200b. After the holes are removed, at 107b a mesh 208 is created. The created mesh 208 is coarser than a similar mesh created on a model where the regularly patterned holes 204 are left in place. In the context of this disclosure, the mesh 208 is a discretizing mesh, applied to the digital model, on which the numerical calculations are performed. For example, the mesh 208 is used to perform a numerical fluid simulation. In some implementations, the regularly patterned holes 204 are omitted from a model prior to a model being obtained. In such implementations, operation 107a can be skipped.

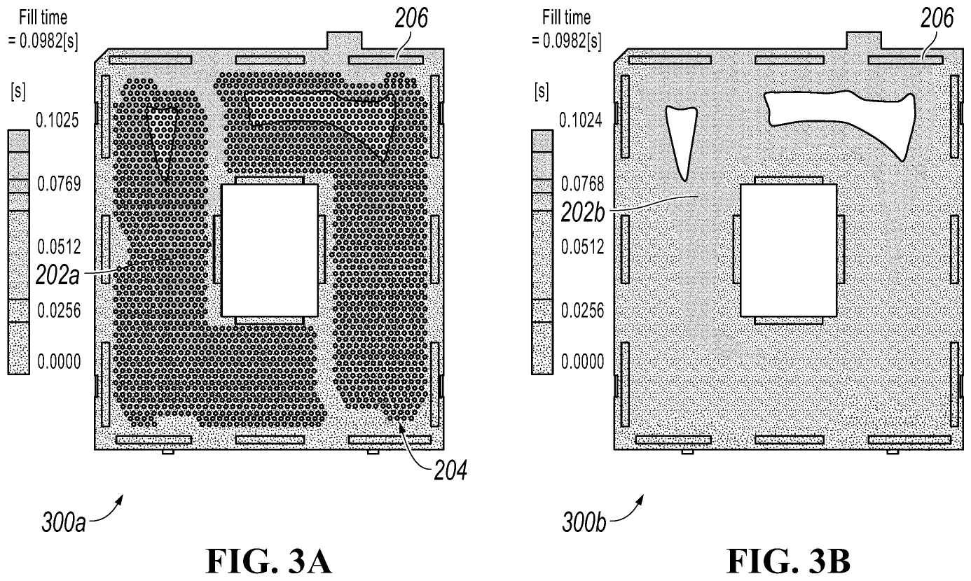

FIG. 3A is a result 300a of a simulation with the example 3D model 200a of a component having a portion with regularly patterned holes 204 being individually modeled during the numerical simulation. FIG. 3B is a result 300b of a simulation with the example 3D model 200b of the component having a portion with regularly patterned holes with the regularly patterned holes 204 removed. More specifically, FIG. 3B is showing the result of simulation using a global model/representation of the first portion to approximate the regularly patterned holes. At 108a, flow characteristics of the first portion 202b of the model are obtained, for example, by using analytical flow results or empirical flow data. At 109a, a flow factor of the first portion 202b is determined based on the analytical flow results or the empirical flow data. The flow factor indicates flow characteristics of fluid flowing through the first portion with the regularly patterned holes and, in some implementations, is used for a model with holes removed and/or not included, such as model 200a. For example, in some implementations, the flow factor is calculated with the following equation:

$$Flow Resistance Factor = Shear Area Ratio * {( \frac{Thickness}{Dist} )}^{( 1 + 2 n )} \qquad ( 1 )$$

where Flow Resistance Factor is the flow factor, where Shear Area Ratio is the shear area in the model without holes over the shear area with holes, where shear area is the surface area of the region where the effective shear by the flow is applied, where Thickness is the local part thickness, where Dist is the local distance between holes (edge to edge), and where n is the power-law index, which is a material characteristic describing the reduction of viscosity which occurs with increasing shear rate. For non-power law flow, the slope of viscosity-shear rate curve at the local temperature, shear rate and pressure condition can be used without departing from this disclosure.

The shear area ratio for a square hole can be calculated from the following equation:

$$Shear Area Ratio ( square hole ) = \frac{W * Depth}{( W + D i s t ) * ( W + D i s t )} \qquad ( 2 )$$

where W is the width of the square hole, and where Depth is the depth of the hole. The shear area ratio of a round hole can be calculated with the following equation:

$$Shear Area Ratio ( round hole ) = \frac{π * D * Depth}{2 * ( D + D i s t ) * ( D + D i s t )} \qquad ( 3 )$$

where D is the diameter of the round hole.

In some implementations, the concepts described herein are used to obtain flow characteristics for blind-holes and/or varied profile holes. Such flow characteristics can be determined from analytical results and/or empirical data to contribute to the determined flow factor. Regardless of the hole patterns or geometry, the flow characteristics through such a regular geometry is simplified into a flow factor that is globally analogous to the discrete calculations provided by a fine mesh used to calculate flow around individual holes. That is, performing iterative calculations with the flow factor produces results substantially similar (for example, plus or minus 5%, plus or minus 10%, plus or minus 15%, or plus or minus 20%) to iterative calculations that include the individual holes. Such examples can be seen in the illustrated simulation results (300a, 300b), which illustrate simulations performed with both methods, result 300a being with discrete holes, and result 300b using the flow factor.

Alternatively or in addition, at 108b, thermal characteristics of the first portion 202b of the model 200b are obtained using analytical thermal results and/or empirical thermal data. At 109b, a thermal factor of the first portion 202b is determined based on the analytical thermal results and/or the empirical thermal data. The thermal factor indicates thermal characteristics of fluid flowing through the first portion 202b with the regularly patterned holes 204, and thermal properties of the component, or mold forming the component, itself. In some implementations, the thermal factor includes a growth rate of a frozen layer. For example, in implementations where plastic mold injection is being simulated, a rate of hardening of the injected liquid plastic is included.

For example, thermal properties (density and heat capacity) of the molding material are modified based on the part volume fraction and shape factor values to account for the effect of grill portion 202b in the temperature solution. In some implementations, the heat capacity at the grill portion 202b is calculated from the following equation:

$$Heat capacity ( grill ) = \frac{Heat capacity ( material )}{S F} \qquad ( 4 )$$

where SF is the shape factor, and where the Heat capacity (material) is the heat capacity of the material injected into a mold.

The density at the grill portion 202b is calculated from the following equation:

Density(grill)=VF*Density(material) (5)

Where VF is part volume fraction of the grill portion, and where Density (material) is the density of the material injected into the mold.

In some implementations, the part volume fraction and shape factor for square holes is calculated from the following set of equations:

PA=(W+Dist)*(W+Dist) (6)

where PA is the projected area.

$$V F = 1 - \frac{W * W}{P A} \qquad ( 7 )$$

where VF is a part volume fraction.

SA(through hole)=2*PA−2*W²+4*W*Depth (8)

SA(blind hole)=2*PA+4*W*Depth (9)

where SA (through hole) is a surface area of a square through-hole, and where SA (blind hole) is a surface area of a blind hole, and Depth is the depth of the hole.

$$S F = \frac{S A}{2 * P A} \qquad ( 10 )$$

where SF is a shape factor.

The part volume fraction and shape factor for round holes can be calculated from the following set of equations:

$$P A = ( D + D i s t ) * ( D + D i st ) \qquad ( 11 )$$

$$VF = 1 - \frac{025 * π * {D}^{2}}{P A} \qquad ( 12 )$$

$$SA ( through hole ) = 2 * PA - 0.5 * π * {D}^{2} + π * D * Depth \qquad ( 13 )$$

$$SA ( blind hole ) = 2 * PA + π * D * Depth \qquad ( 14 )$$

$$SF = \frac{S A}{2 * P A} \qquad ( 15 )$$

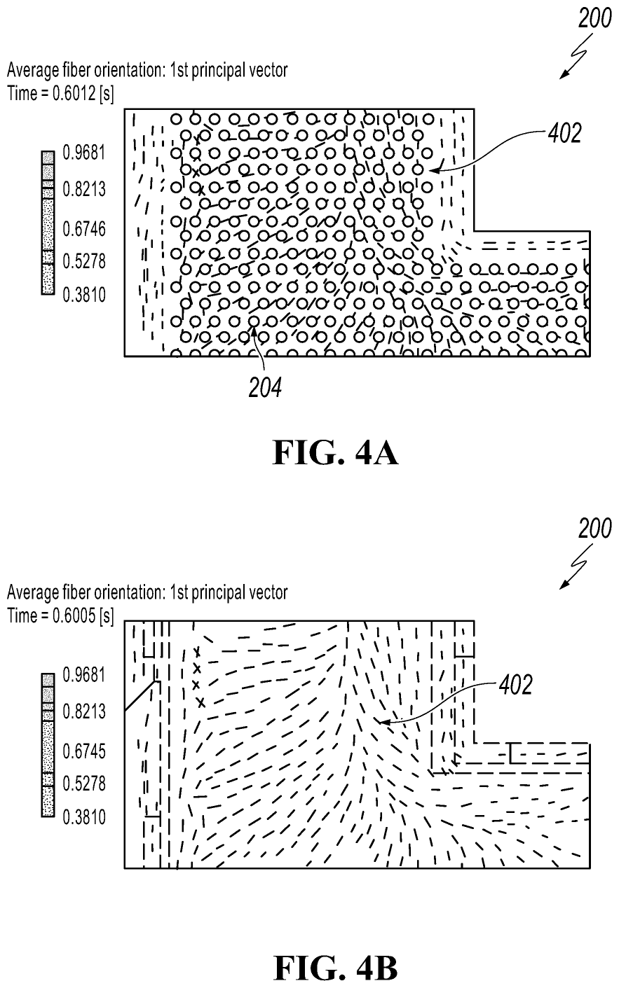

FIG. 4A is a result of a simulation with the example 3D model 200a of the component 200 having a portion with regularly patterned holes 204. FIG. 4B is a result of a simulation with the example 3D model 200b of a component having a portion with regularly patterned holes 204 with the holes 204 removed. More specifically, FIG. 4B is showing the result of simulation using a global model/representation of the first portion to approximate the regularly patterned holes. Alternatively or in addition, at 108c, fiber orientation characteristics of suspended fibers 402 flowing through the first portion 202b are obtained through analytical results and/or empirical fiber orientation data. At 109c, a fiber orientation factor is determined based on analytical results or the empirical fiber orientation data. The fiber orientation factor indicates how fibers 402 suspended in the fluid are oriented within the fluid flow. For example, in some implementations, a rotational diffusion model of fiber orientation is used. In such implementations, the fiber orientation is assumed to be in the planar directions of the grill portion. As such, the following equations can be used:

GRAF=1+HF*(1−VF) (16)

where GRAF is a grill region fiber adjustment factor, and where HF is a heuristic factor. In some implementations, the value of the heuristic factor is empirically determined. In some implementations, the heuristic factor is on the order of a few hundred, for example one hundred ninety-nine.

In some implementations, the fiber orientation factor is modified to account for changes in the flow factor and/or the thermal factor. For example, changes in flow regimes can impact a rotation rate of suspended fibers. Alternatively or in addition, fibers can be entrapped in the frozen layer, and further impact the flow regime depending upon the fiber's orientation.

In some implementations, the flow factor is dynamically modified to account for the growth rate of the frozen layer. That is, the flow factor is dependent upon the thickness of the frozen layer, and changes with the thickness of the frozen layer. The frozen layer effect can be included by changing the flow resistance factor. For this, the modified distance between hole values is used in the flow resistance factor calculation:

$${Flow Resistance Factor = Shear Area Ratio * ( \frac{Thic k n e s s}{Dist\_modified} )}^{( 1 + 2 n )} \qquad ( 17 )$$

$${Dist}_{- modified} = D i s t - H F * FLF * Thickness \qquad ( 18 )$$

where Dist_modified is the modified distance between holes, HF is a heuristic factor, FLF is frozen-layer fraction, and Thickness is the local part thickness.

Similarly, the thermal factor can be dependent upon the flow factor as flow regimes have an impact on thermal convection. As such, in some implementations, the operations of determining the flow factor (108a), determining the thermal factor (108b), and/or determining the fiber orientation factor (108c) are coupled to one another. In such implementations, operations 108a, 108b, and 108c are performed simultaneously, concurrently, iteratively, or subsequently with one another in any suitable combination. For example, operations 108a and operations 108b can be performed together while operation 108c is omitted, operations 108a and operations 108c can be performed together while operation 108b is omitted, operations 108b and 108c can be performed together while operation 108a is omitted. Nonetheless, in some implementations, any one of the operations 108a, 108b, or 108c is performed on its own without any of the other operations being performed. While a number of example equations have been provided, such equations are meant only as examples of specific implementations. Other equations for analytical or numerical solving can be used to determine flow factors, thermal factors, and/or fiber orientation factors without departing from this disclosure.

At 110, a numerical simulation of fluid flow through the component is performed using the mesh 208 (FIG. 2B). In some instances, performing the numerical fluid simulation includes modifying a thermal property of the fluid simulation in the first portion based at least in part on the thermal factor. In some implementations, performing the numerical fluid simulation includes modifying a fiber orientation property of the fluid simulation in the first portion based at least in part on the fiber orientation factor. In some implementations, performing the numerical fluid simulation includes modifying a fluid flow property based at least in part on the flow factor. In some implementations, any combination of the aforementioned properties is modified by the flow factor, the thermal factor, and/or the fiber orientation factor.

At 112, results of the simulation are provided. The results of the numerical simulation can be used for a variety of applications, for example, when used to simulate mold injection, the numerical simulation can be used to predict filling pattern, the potential for air-traps at the last point to fill, and the polymer cooling (and freezing) rate. Injection locations, injection rates, and injection temperatures may then be altered (or freshly determined) due to these predicted outcomes, with new injection locations selected which seek to avoid undesirable filling patterns, weld-lines, and air-traps. That is, at 114, one or more components, such as one or more molds, are manufactured based on the results of the simulation. Further, these mold filling simulations can also be the basis of subsequent predictions of the final part shape (“warpage”) which rely on the fiber orientation, pressure, and temperature outcomes of the filling simulation to determine the material properties and residual stresses (these are the inputs to the warpage calculation). In some implementations, warpage calculations and/or simulations are also performed using the model 200b without holes.

A digital 3D model (which for brevity will simply be referred to as a model) may, but need not, correspond to a file. The model may be stored in a portion of a file that holds other models (for example, an assembly file), in a single file dedicated to the model in question, or in multiple coordinated files.

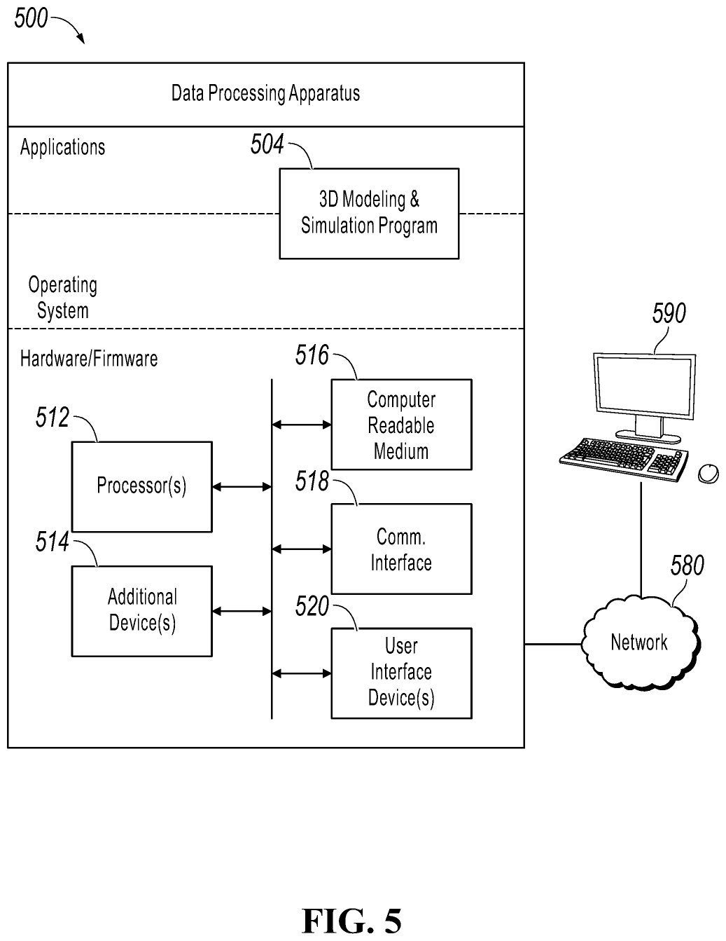

FIG. 5 is a schematic diagram of a data processing system including a data processing apparatus 500, which can be programmed as a client or as a server. The data processing apparatus 500 is connected with one or more computers 590 through a network 580. While only one computer is shown in FIG. 5 as the data processing apparatus 500, multiple computers can be used. The data processing apparatus 500 includes various software modules, which can be distributed between an application layer and an operating system. These can include executable and/or interpretable software programs or libraries, including tools and services of a 3D modeling and simulation program 504, such as described above. The number of software modules used can vary from one implementation to another. Moreover, the software modules can be distributed on one or more data processing apparatus connected by one or more computer networks or other suitable communication networks.

The data processing apparatus 500 also includes hardware or firmware devices including one or more processors 512, one or more additional devices 514, a computer readable medium 516, a communication interface 518, and one or more user interface devices 520. Each processor 512 is capable of processing instructions for execution within the data processing apparatus 500. In some implementations, the processor 512 is a single or multi-threaded processor. Each processor 512 is capable of processing instructions stored on the computer readable medium 516 or on a storage device such as one of the additional devices 514. The data processing apparatus 500 uses its communication interface 518 to communicate with one or more computers 590, for example, over a network 580. Examples of user interface devices 520 include a display, a camera, a speaker, a microphone, a tactile feedback device, a keyboard, and a mouse. The data processing apparatus 500 can store instructions that implement operations associated with the program(s) described above, for example, on the computer readable medium 516 or one or more additional devices 514, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this disclosure contains many specific implementation details, these should not be construed as limitations on the scope of what may be claimed, but rather as descriptions of features specific to particular implementations. For example, while primarily described in the context of modeling injection molding, the subject matter described throughout this disclosure is applicable to other simulations, for example Computation Fluid Dynamics modelling of flow through complex lattice-like Additive Manufactured parts (i.e. for CFD of Volumetric Kernel modelled geometries). Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. Aspects of this disclosure can be realized using either 3D discretization models, shell (i.e. 2D) modelling and 1D modelling representations as well as in mixed modelling (where some regions are 3D while others are 2D etc.

What is claimed is:

1. A method performed by a data processing apparatus, the method comprising:
obtaining a digital 3D model of a component to be analyzed, the component including regularly patterned holes;
identifying a first portion of the model, the first portion including the regularly patterned holes;
identifying a second portion of the model, the second portion including parts of the model lacking the regularly patterned holes;
determining a flow factor of the first portion, the flow factor indicating flow characteristics of fluid flowing through the first portion with the regularly patterned holes; and
performing a numerical fluid simulation, using a mesh representative of the component geometry, the performing comprising modifying a flow property of the fluid simulation in the first portion based at least in part on the flow factor.

2. The method of claim 1, further comprising determining a thermal factor, the thermal factor indicating thermal characteristics of fluid flowing through the first portion with the regularly patterned holes, the thermal factor including a growth rate of a frozen layer.

3. The method of claim 1, further comprising:
modifying the flow factor dynamically to account for a growth rate of a frozen layer.

4. The method of claim 1, wherein the regularly patterned holes are included in the digital 3D model, the method further comprising:
removing the holes in the 3D model; and
creating the mesh, used to perform the numerical fluid simulation, after removing the holes in the 3D model.

5. The method of claim 1, wherein the regularly patterned holes are omitted from the digital 3D model, the method further comprising:
obtaining flow characteristics of the first portion of the model using analytical flow results or empirical flow data, wherein determining the flow factor is done based on the analytical flow results or the empirical flow data;
obtaining thermal characteristics of the first portion of the model using analytical thermal results or empirical thermal data;
determining a thermal factor based on the analytical thermal results or the empirical thermal data;
obtaining fiber orientation characteristics of the first portion of the model using analytical results or empirical fiber orientation data for fibers suspended in the fluid flow; and
determining a fiber orientation factor based on the analytical results or the empirical fiber orientation data.

6. The method of claim 1, wherein the regularly patterned holes comprise blind holes, wherein determining the flow factor comprises obtaining flow characteristics of the blind holes using analytical results or empirical data.

7. The method of claim 1, wherein the regularly patterned holes comprise a varied profile hole, wherein the varied profile hole defines a varied cross-sectional shape across a depth of the hole, wherein determining the flow factor comprises obtaining flow characteristics of the varied profile hole using analytical results or empirical data.

8. A system comprising:
one or more processors; and
a computer-readable medium storing instructions executable by the one or more processors to perform cause the one or more processors to:
obtain a digital 3D model of a component to be analyzed, the component including regularly patterned holes;
identify a first portion of the model, the first portion including the regularly patterned holes;
identify a second portion of the model, the second portion including parts of the model lacking the regularly patterned holes;
determine a thermal factor of the first portion, the thermal factor indicating a thermal characteristic of fluid flowing through the first portion with the regularly patterned holes, the thermal factor comprising a growth rate of a frozen layer; and
perform a numerical fluid simulation, using a mesh representative of the component geometry, wherein performance of the numerical fluid simulation comprises modifying a thermal property of the numerical fluid simulation in the first portion based at least in part on the thermal factor, the numerical fluid simulation used to determine an injection flow rate or an injection location of an injection mold.

9. The system of claim 8, wherein the regularly patterned holes are included in the digital 3D model, wherein the instructions further cause the one or more processor to:
remove the holes in the 3D model; and
create the mesh after removal of the holes in the 3D model.

10. The system of claim 8, wherein the regularly patterned holes are omitted from the digital 3D model, wherein the instructions further cause the one or more processor to:
obtain flow characteristics of the first portion of the model using analytical flow results or empirical flow data;
determine a flow factor of the first portion, the flow factor indicating flow characteristics of fluid flowing through the first portion with the regularly patterned holes, wherein determination of the flow factor is done based on the analytical flow results or the empirical flow data;
obtain thermal characteristics of the first portion of the model using analytical thermal results or empirical thermal data, wherein determination of the thermal factor is done based on the analytical thermal results or empirical thermal data;
obtain fiber orientation characteristics of the first portion of the model using analytical results or empirical fiber orientation data for fibers suspended in the fluid flow; and
determine a fiber orientation factor based on the analytical results or the empirical fiber orientation data.

11. The system of claim 10, wherein the instructions further cause the one or more processor to:
modify the flow factor dynamically to account for the growth rate of the frozen layer.

12. The system of claim 10, wherein the regularly patterned holes comprise blind holes, wherein the instructions further cause the one or more processor to:
determine the flow factor by obtaining flow characteristics of the blind holes using analytical results or empirical data.

13. The system of claim 10, wherein the regularly patterned holes comprise a varied profile hole that defines a varied cross-sectional shape across a depth of the hole, wherein the instructions further cause the one or more processor to:
determine the flow factor by obtaining flow characteristics of the varied profile hole using analytical results or empirical data.

14. A computer-readable medium storing instructions executable by one or more processors to perform operations comprising:
obtaining a digital 3D model of a component to be analyzed, the component including regularly patterned holes;
identifying a first portion of the model, the first portion including the regularly patterned holes;
identifying a second portion of the model, the second portion including parts of the model lacking the regularly patterned holes;
determining a fiber orientation factor, the fiber orientation factor indicating fiber orientation characteristics indicative of fiber orientation properties of fibers suspended within a fluid flowing through the first portion with the regularly patterned holes; and
performing a numerical fluid simulation, using mesh representative of the component geometry, the performing comprising modifying a fiber orientation property of the numerical fluid simulation in the first portion based at least in part on the fiber orientation factor.

15. The computer-readable medium of claim 14, wherein the operations further comprise:
determining a flow factor of the first portion, the flow factor indicating flow characteristics of fluid flowing through the first portion with the regularly patterned holes; and
determining a thermal factor of the first portion, the thermal factor indicating thermal characteristic of fluid flowing through the first portion with the regularly patterned holes, the thermal factor comprising a growth rate of a frozen layer.

16. The computer-readable medium of claim 15, wherein the operations further comprise:
modifying the flow factor dynamically to account for the growth rate of the frozen layer.

17. The computer-readable medium of claim 15, wherein the regularly patterned holes comprise blind holes, wherein determining the flow factor comprises obtaining flow characteristics of the blind holes using analytical results or empirical data.

18. The computer-readable medium of claim 15, wherein the regularly patterned holes comprise a varied profile hole, wherein the varied profile hole defines a varied cross-sectional shape across a depth of the hole, wherein determining the flow factor comprises obtaining flow characteristics of the varied profile hole using analytical results or empirical data.

19. The computer-readable medium of claim 15, wherein the operations further comprise:
determining an injection rate, with iterative calculations using the mesh, based in part on the determined flow factor and the determined thermal factor;
determining an injection temperature, with iterative calculations using the mesh, based in part on the determined flow factor and the determined thermal factor; and
determining an injection location, with iterative calculations using the mesh, based in part on the determined injection rate and injection temperature.

20. The computer-readable medium of claim 14, wherein the regularly patterned holes are included in the digital 3D model, wherein in the operations further comprise:
removing the holes in the 3D model; and
creating the mesh after removing the holes in the 3D model.
